(19) United States
(12) Patent Application Publication
(10) Pub. No.: US 2017/0159638 A1
(43) Pub. Date: Jun. 8, 2017

(54) HYDRAULIC ROTARY MACHINE

(71) Applicant: KYB Corporation, Tokyo (JP)

(72) Inventors: Ryunosuke ISHIKAWA, Kanagawa (JP); Yoshihiro OOBAYASHI, Kanagawa (JP)

(73) Assignee: KYB Corporation, Tokyo (JP)

(21) Appl. No.: 15/324,412

(22) PCT Filed: Jun. 25, 2015
(86) PCT No.: PCT/JP2015/068373

§ 371 Date: Jan. 6, 2017

(30) Foreign Application Priority Data
Jul. 7, 2014 (JP) 2014-139540

(51) Int. Cl. F03C 1/06; F04B 9/111; F04B 3/00; F03C 1/22; F04B 1/22

(52) U.S. Cl. CPC F03C 1/0642; F03C 1/22; F04B 1/22; F04B 3/00; F04B 9/111

(57) ABSTRACT

A hydraulic rotary machine includes a plurality of pistons, a cylinder block accommodating the pistons, a shaft penetrating through the cylinder block, a swash plate making the pistons reciprocate to expand and contract a capacity chamber of the cylinder, a casing accommodating the cylinder block, a front cover closing an opened end of the casing, an extending portion formed in the front cover and extending along the shaft towards the cylinder block, and a first slide bearing provided between the extending portion and the cylinder block. The first slide bearing is fixed to the extending portion or the cylinder block by a pin member.

### TECHNICAL FIELD

The present invention relates to a hydraulic rotary machine used as a piston pump or a piston motor.

### BACKGROUND ART

For example, a piston pump described in JP2005-133647A is known as a hydraulic rotary machine. JP2005-133647A discloses an axial piston pump that includes a bearing between an outer circumference of a cylinder block and an inner circumference of a casing.

### SUMMARY OF INVENTION

However, the axial piston pump including a bearing between an outer circumference of a cylinder block and an inner circumference of a casing requires forming a sliding contact portion brought into sliding contact with the bearing by extending from an outer circumferential surface of the cylinder block, and requires securing a space for disposing the bearing on the inner circumferential side of the case. Therefore, there was the problem that the outer diameter of the pump increases in size. Moreover, since the range that the bearing is provided is broad, the amount of material used for the bearing increases, which thus causes the problem of high material costs. In order to overcome such problems, considerations may be made to dispose the bearing on the shaft side of the cylinder block, however when a large torque acts on the bearing, the bearing may loosen and the function as a bearing may not be exhibited.

An object of the present invention is to make a hydraulic rotary machine compact and prevent the loosening of a bearing.

According to one aspect of the present invention, a hydraulic rotary machine includes a plurality of pistons, a rotatable cylinder block including a plurality of cylinders for accommodating the pistons, a shaft penetrating through the cylinder block and coupling to the cylinder block, a swash plate configured to cause reciprocation of the piston in accordance with the rotation of the cylinder block so as to expand and contract a capacity chamber of the cylinder, a case member supporting one end of the shaft and accommodating the cylinder block, a cover member through which the other end of the shaft is inserted, the cover member closing an opened end of the case member, an extending portion formed in the cover member, the extending portion extending along the shaft towards the cylinder block, and a first slide bearing provided between the extending portion and the cylinder block. The first slide bearing is fixed to the extending portion or the cylinder block by a fixing means.

### BRIEF DESCRIPTION OF DRAWINGS

FIG. 1 is a sectional view of a hydraulic rotary machine according to an embodiment of the present invention;

FIG. 2 is an enlarged view of an II part in FIG. 1;

FIG. 3 is a sectional view taken on line in FIG. 2;

FIG. 4 is a view showing a first modified example of a fixing means; and

FIG. 5 is a view showing a second modified example of the fixing means.

### DESCRIPTION OF EMBODIMENTS

Hereinafter, a hydraulic rotary machine according to an embodiment of the present invention will be described with reference to the drawings.

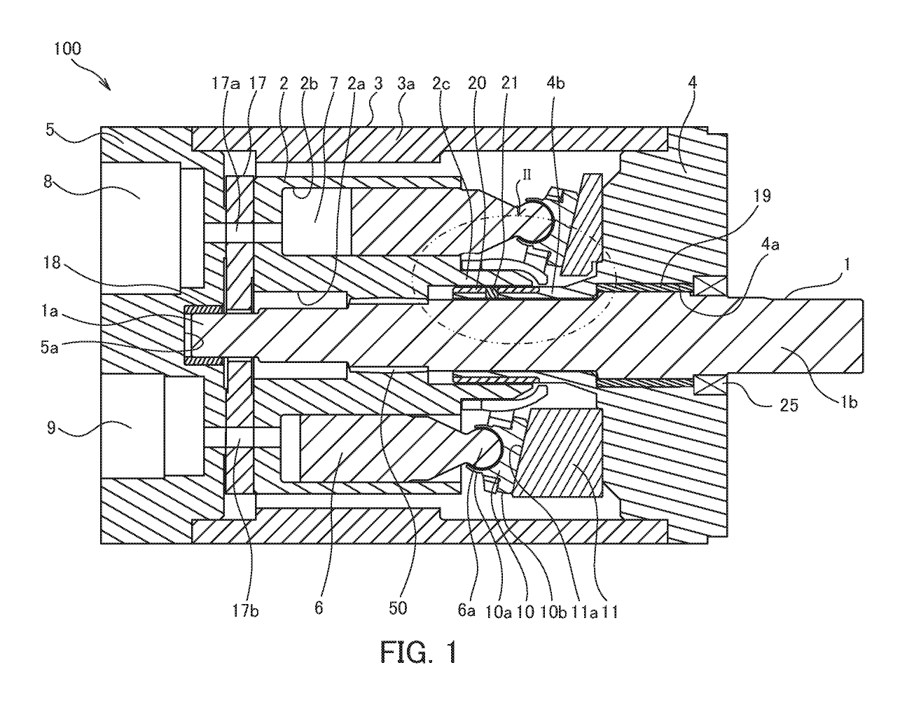

The present embodiment describes a case where the hydraulic rotary machine is a hydraulic piston pump motor 100 in which water serves as a working fluid. As shown in FIG. 1, the hydraulic piston pump motor 100 functions as a pump that supplies water serving as the working fluid, by a shaft 1 rotating due to extraneous power and pistons 6 reciprocating due to the rotation, and functions as a motor that outputs rotation drive force, by the pistons 6 reciprocating by fluid pressure of water extraneously supplied and the shaft 1 rotating due to the reciprocation.

The description hereinafter exemplifies a case in which the hydraulic piston pump motor 100 is used as a piston pump, and the hydraulic piston pump motor 100 will simply be called as the “piston pump 100”.

The piston pump 100 is a hydraulic piston pump in which water serves as the working fluid. The piston pump 100 includes a shaft 1 that rotates by a power source, a cylinder block 2 coupled to the shaft 1 and which rotates in accordance with the rotation of the shaft 1, and a casing 3 that accommodates the cylinder block 2. The casing 3 includes a case main body 3a whose both ends are opened, an end cover 5 that supports one end of the shaft 1 and closes one of the opened ends of the case main body 3a, and a front cover 4 through which the other end of the shaft 1 is inserted and which serves as a cover member for closing the other one of the opened ends of the case main body 3a.

Here, the case main body 3a coupled with the end cover 5 corresponds to the case member recited in the claims. In the present embodiment, the case main body 3a and the end cover 5 are formed as separate members. Instead of this, the case main body 3a and the end cover 5 may be formed integrally. In this case, the case main body 3a and the end cover 5 that is integrally formed will correspond to the case member recited in the claims.

The one end portion 1a of the shaft 1 is accommodated in an accommodating recessed portion 5a provided in the end cover 5. The other end portion lb of the shaft 1 projects externally from the front cover 4, and is coupled to the power source.

The cylinder block 2 has a through hole 2a through which the shaft 1 penetrates, and is splined to the shaft 1 at a coupling portion 50. Accordingly, the cylinder block 2 rotates in accordance with the rotation of the shaft 1.

In the cylinder block 2, a plurality of cylinders 2b having an opening on one end surface thereof is formed in parallel to the shaft 1. The plurality of cylinders 2b is formed at predetermined intervals in a circumferential direction of the cylinder block 2. A cylindrical piston 6 that partitions a capacity chamber 7 is inserted into the cylinder 2b in a reciprocatable manner. A leading end side of the piston 6 projects from the opening of the cylinder 2b, and a spherical base 6a is formed on a leading end portion thereof.

The piston pump 100 further includes shoes 10 respectively coupled to the leading end portions of the pistons 6 in a rotatable manner, and swash plates 11 with which a respective one of the shoes 10 is brought into sliding contact in accordance with the rotation of the cylinder block 2.

The shoe 10 includes a receiving portion 10a that receives the spherical base 6a formed on the leading end of the piston 6, and a circular flat plate portion 10b that is brought into sliding contact with the swash plate 11. An inner surface of the receiving portion 10a is formed in a spherical shape, and is brought into sliding contact with an outer surface of the received spherical base 6a. The shoe 10 is displaceable in angle in any direction with respect to the spherical base 6a.

The swash plate 11 is fixed to an inner wall of the front cover 4, and has a sliding contact surface 11a tilted from a direction perpendicular to an axis of the shaft 1. The flat plate portion 10b of the shoe 10 is brought into surface contact with the sliding contact surface 11a.

A through hole 4a through which the shaft 1 is inserted is formed in the front cover 4. A second slide bearing 19 that supports the shaft 1 in a rotatable manner is fitted to the through hole 4a. Moreover, the front cover 4 is provided with sealing material 25 so that water does not leak outside from between the shaft 1 and the front cover 4.

The front cover 4 further has a tubular extending portion 4b formed thereto, which tubular extending portion 4b extends towards the cylinder block 2 along the shaft 1. A first slide bearing 20 is press fitted to an outer circumferential surface of the extending portion 4b. A tubular sliding contact portion 2c is formed in the cylinder block 2 that is positioned facing the outer circumferential surface of the extending portion 4b, and the tubular sliding contact portion 2c is brought into sliding contact with the first slide bearing 20. Since the inner circumferential surface of the sliding contact portion 2c is brought into sliding contact with the outer circumferential surface of the first slide bearing 20, the cylinder block 2 is supported in a rotatable manner by the front cover 4.

Here, a torque from the rotatable cylinder block 2 acts on the first slide bearing 20 press fitted into the outer circumferential surface of the extending portion 4b. When this torque is large, the press fitting of the first slide bearing 20 may loosen. Thereby, this may cause the first slide bearing 20 to loosen with respect to the extending portion 4b or to come off from the extending portion 4b. Therefore, the first slide bearing 20 must be securely fixed to the extending portion 4b.

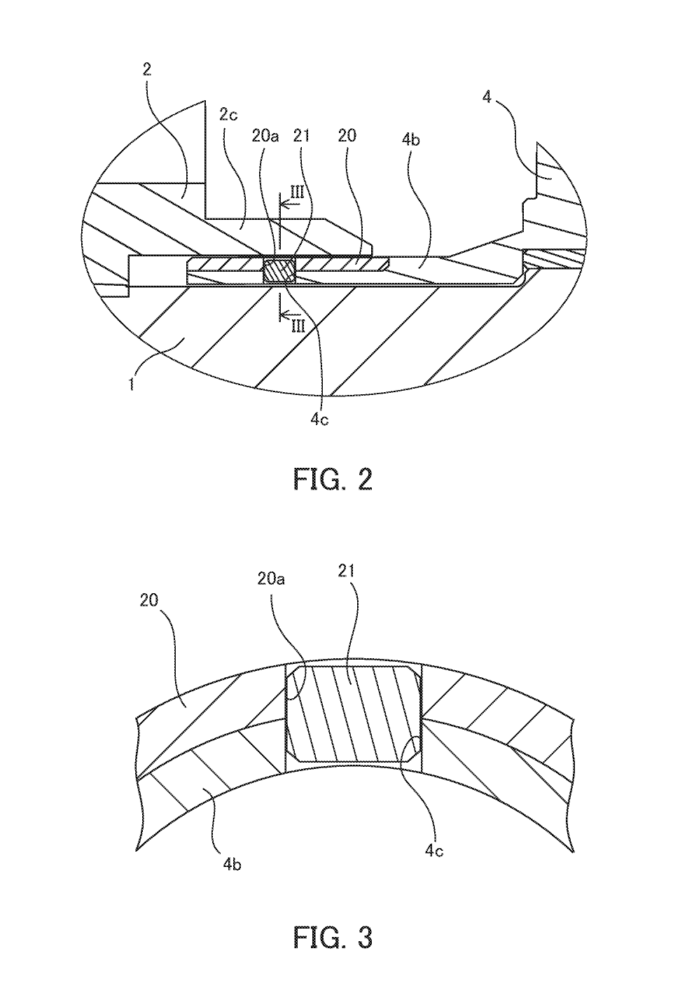

In the present embodiment, the first slide bearing 20 is fixed to the extending portion 4b by a pin member 21 serving as a fixing means, as shown in an enlarged manner in FIG. 2 and FIG. 3. FIG. 2 is an enlarged view of an II part in FIG. 1, showing an enlarged view of the pin member 21 and its surroundings, and is shown omitting the members other than the shaft 1, the cylinder block 2, and the front cover 4. FIG. 3 is a view showing a section taken on line in FIG. 2, in an enlarged manner.

As shown in FIG. 2 and FIG. 3, the pin member 21 is press fitted into a through hole 20a that penetrates through the first slide bearing 20, and a fixing hole 4c that penetrates through the extending portion 4b. The through hole 20a and the fixing hole 4c are formed by common hole machining in a state in which the first slide bearing 20 is press fitted into the outer circumferential surface of the extending portion 4b. Since the pin member 21 attaches closely to the through hole 20a and the fixing hole 4c, the loosening of the first slide bearing 20 with respect to the extending portion 4b and the coming off of the first slide bearing 20 from the extending portion 4b is prevented. Moreover, the length of the pin member 21 in the press fitting direction is, as shown in FIG. 3, set to not project out from the outer circumferential surface of the first slide bearing 20 and the inner circumferential surface of the extending portion 4b. Therefore, the pin member 21 will not be in contact with the sliding contact portion 2c with which the first slide bearing 20 is brought into sliding contact and the shaft 1 that is adjacent to the inner circumferential side of the extending portion 4b. In the present embodiment, the first slide bearing 20 is press fitted into the outer circumferential surface of the extending portion 4b, however the first slide bearing 20 may be formed on the outer circumferential surface of the extending portion 4b by molding.

Moreover, in the present embodiment, the fixing hole 4c formed in the extending portion 4b penetrates through the extending portion 4b. Instead of this, the fixing hole 4c may be formed as a bottomed hole closed on the shaft 1 side. In this case, the pin member 21 is regulated in movement to the shaft 1 side by abutting to a bottom portion of the fixing hole 4c, and thus positioning thereof is carried out easily.

Moreover, as the fixing means, a locking screw may be used instead of the pin member 21. In this case, a female thread portion is fabricated on both or either one of the fixing hole 4c of the extending portion 4b and the through hole 20a of the first slide bearing 20. The screwing of the locking screw to this female thread portion allows for preventing the loosening of the first slide bearing 20 with respect to the extending portion 4b and the first slide bearing 20 coming off from the extending portion 4b.

As shown in FIG. 1, a supply passage 8 that guides water to be sucked into the capacity chamber 7 and a discharge passage 9 that guides water discharged from the capacity chamber 7 are formed in the end cover 5. The end cover 5 further includes a third slide bearing 18 that fits to the inner circumferential surface of the accommodating recessed portion 5a. The end cover 5 supports the one end portion 1a of the shaft 1 that is accommodated in the accommodating recessed portion 5a in a rotatable manner, via the third slide bearing 18.

The first to third slide bearings 18 to 20 are formed of resin, ceramic, DLC (Diamond Like Carbon) or like material. The material of the first to third slide bearings 18 to 20 may be any material as long as it can ensure slidability, particularly even when the working fluid is water.

The piston pump 100 further includes a valve plate 17 interposed between the cylinder block 2 and the end cover 5.

The valve plate 17 is a disc member with which a base end surface of the cylinder block 2 is brought into sliding contact, and is fixed to the end cover 5. A supply port 17a connecting the supply passage 8 with the capacity chamber 7, and a discharge port 17b connecting the discharge passage 9 with the capacity chamber 7, are formed in the valve plate 17.

Next, actions of the piston pump 100 will be described.

When the shaft 1 is driven and rotated by extraneous power and the cylinder block 2 is rotated in accordance with the rotation of the shaft 1, the flat plate portions 10b of the shoes 10 are brought into sliding contact with the respective swash plate 11, and the pistons 6 reciprocate within the cylinders 2b by a stroke amount in accordance with a tilting angle of the swash plate 11. The reciprocation of the pistons 6 causes the capacities of the capacity chambers 7 to increase or decrease.

Water is guided to the capacity chamber 7 that is enlarged by rotation of the cylinder block 2, through the supply passage 8 and the supply port 17a. Pressure of the water suctioned into the capacity chamber 7 is boosted by reduction of the capacity chambers 7 due to the rotation of the cylinder block 2, and the water is discharged through the discharge port 17b and the discharge passage 9. In such a way, suction and discharge of the water are continuously performed in accordance with the rotation of the cylinder block 2, in the piston pump 100.

According to the above embodiment, the following effects are achieved.

Since the first slide bearing 20 is provided between the extending portion 4b of the front cover 4 and the cylinder block 2, there is no need to form a sliding contact portion that is brought into sliding contact with the bearing, on the outer circumferential surface of the cylinder block 2. Accordingly, the outer diameter of the cylinder block 2 is made smaller, thus allowing for making the hydraulic rotary machine 100 compact.

Moreover, since the first slide bearing 20 is provided between the extending portion 4b of the front cover 4 and the cylinder block 2, the diameter of the bearing becomes smaller than a case in which the slide bearing is provided between the outer circumference of the cylinder block 2 and the inner circumference of the casing 3, and thus a range in which the bearing is disposed becomes narrow. This accordingly reduces the amount of bearing material used, which thus allows for the reduction of manufacturing costs.

Meanwhile, as the area of the bearing is reduced, the torque that acts on the first slide bearing 20 from the cylinder block 2 increases. However, since the first slide bearing 20 is fixed to the front cover 4 by the pin member 21, it is possible to prevent the loosening of the first slide bearing 20, and it is possible to prevent the first slide bearing 20 from falling off from the front cover 4.

Moreover, since slide bearings formed of material that can secure slidability even when the working fluid is water are used as the bearings 18 to 20, problems such as seizing will not occur even in a case in which water having low lubricity is used as the working fluid. Furthermore, in the present embodiment, the rotational object including the shaft 1 and the cylinder block 2 is supported by three slide bearings; accordingly, contact pressure applied on each of the slide bearings is dispersed. Therefore, it is possible to improve the durability of the hydraulic rotary machine even in a case in which water having poor lubricity is used as the working fluid.

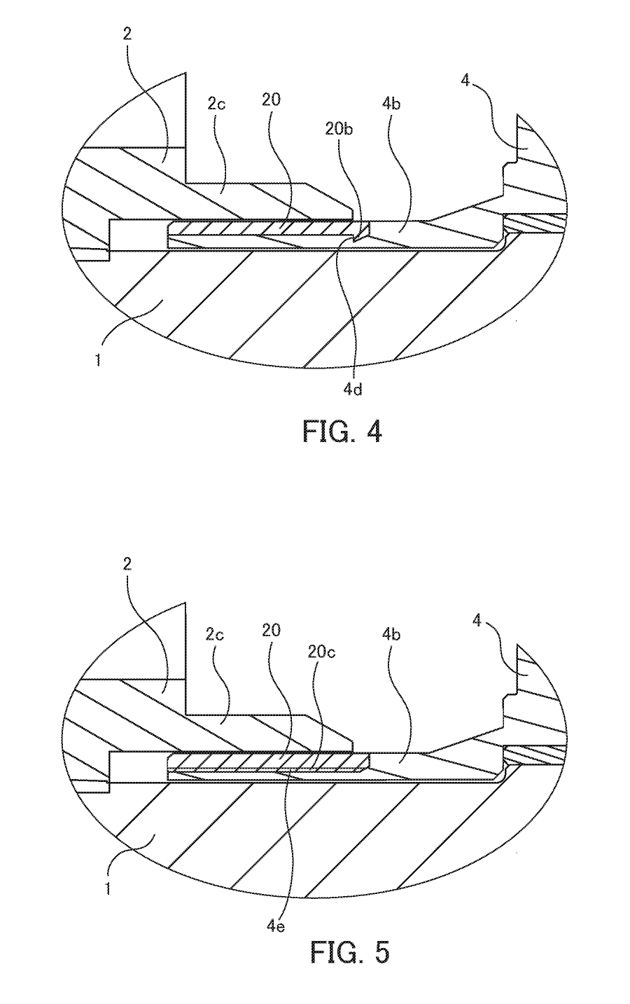

Hereinafter, a modified example of the aforementioned fixing means will be described with reference to FIG. 4 and FIG. 5. FIG. 4 and FIG. 5 are drawings that correspond to FIG. 2.

In the first modified example shown in FIG. 4, as a fixing means, a projection portion 20b that projects inwards in the radial direction is formed on the inner circumferential surface of the first slide bearing 20, and a locking recessed portion 4d to which the projection portion 20b of the first slide bearing 20 locks is formed on the outer circumference surface of the extending portion 4b. The first sliding bearing 20 is fixed to the extending portion 4b by a locking structure in which the projection portion 20b engages with the locking recessed portion 4d. Therefore, also in the first modified example, effects are obtained as with the above embodiment that the loosening of the first slide baring 20 can be prevented and that the falling off of the first slide bearing 20 from the front cover 4 can be prevented.

In the first modified example, the projection portion 20b and the locking recessed portion 4d may be formed along the whole circumference, or a plurality thereof may be formed along the circumferential direction. Moreover, the projection portion 20b and the locking recessed portion 4d may be provided at any position in the axial direction of the first slide bearing 20. Moreover, in the first modified example, the projection portion 20b is formed on the first slide bearing 20 side and the locking recessed portion 4d is formed on the extending portion 4b side. However, instead of this, the projection portion may be formed on the extending portion 4b side and the locking recessed portion may be formed on the first slide bearing 20 side.

Moreover, in the first modified example, the first slide bearing 20 may be formed of resin material, and in this case, the first slide bearing 20 is molded to the extending portion 4b. By engaging the projection portion 20b formed by molding with the locking recessed portion 4d, the first slide bearing 20 is fixed to the extending portion 4b. In order to improve the adhesiveness of the molding, a plurality of rugged portions may be further provided on the outer circumferential surface of the extending portion 4b.

In the second modified example shown in FIG. 5, a female thread 20c is formed on the inner circumferential surface of the first slide bearing 20, and a male thread 4e that screws to the female thread 20c of the first slide bearing 20 is formed on the outer circumferential surface of the extending portion 4b. By screwing the first slide bearing 20 in the same direction as the rotational direction of the cylinder block 2 to the male thread 4e of the extending portion 4b, the first slide bearing 20 is fixed to the extending portion 4b. If the direction in which the first slide bearing 20 is screwed and the rotational direction of the cylinder block 2 are the same, the first slide bearing 20 will not loosen. Accordingly, in a case in which the hydraulic rotary machine 100 is used as a piston pump whose rotational direction of the cylinder block 2 is constant, this is particularly useful. Therefore, also in the second modified example, the effects are obtained as with the above embodiments that the loosening of the first slide bearing 20 can be prevented and that the falling off of the first slide bearing 20 from the front cover 4 can be prevented.

Together with the above fixing means, or alternatively, as an independent fixing means for fixing the first slide bearing 20, an adhesive may be used. The adhesive is applied on a contacting surface of the first slide bearing 20 and the extending portion 4b, and the first slide bearing 20 is bonded to the extending portion 4b via the adhesive. Even in the case in which the adhesive is used as the fixing means, the effects are obtained as with the above embodiments that the loosening of the first slide bearing 20 can be prevented and that the falling off of the first slide bearing 20 from the front cover 4 can be prevented. The fixing means of the first slide bearing 20 is not limited to these, and may be of any form as long as it prevents the first slide bearing 20 from coming off from the extending portion 4b.

In the above embodiment, the first modified example, and the second modified example, the first slide bearing 20 provided between the cylinder block 2 and the front cover 4 is fixed on the front cover 4 side. Instead of this, the first slide bearing 20 may be fixed on the cylinder block 2 side. In this case, the first slide bearing 20 is fixed on the inner circumference side of the sliding contact portion 2c of the cylinder block 2 by any of the above fixing means, and is brought into sliding contact with the outer circumferential surface of the extending portion 4b of the front cover 4.

The embodiments of the present invention described above are merely illustration of some application examples of the present invention and not of the nature to limit the technical scope of the present invention to the specific constructions of the above embodiments.

In the prevent embodiment, although water is used as the working fluid, a working fluid such as working oil or an aqueous alternative fluid may be used instead of this. Moreover, although the piston pump motor 100 is one whose angle of the swash plate 11 is of a fixed type, this may be a variable capacity type piston pump motor whose tilting angle of the swash plate can be changed.

The present application claims a priority based on Japanese Patent Application No. 2014-139540 filed with the Japan Patent Office on Jul. 7, 2014, all the contents of which are hereby incorporated by reference.

1. A hydraulic rotary machine comprising:
a plurality of pistons;
a rotatable cylinder block including a plurality of cylinders for accommodating the pistons;
a shaft penetrating through the cylinder block and coupling to the cylinder block;
a swash plate configured to cause reciprocation of the piston in accordance with the rotation of the cylinder block so as to expand and contract a capacity chamber of the cylinder;
a case member supporting one end of the shaft and accommodating the cylinder block;
a cover member through which the other end of the shaft is inserted, the cover member closing an opened end of the case member;
an extending portion formed in the cover member, the extending portion extending along the shaft towards the cylinder block; and
a first slide bearing provided between the extending portion and the cylinder block, wherein
the first slide bearing is fixed to the extending portion or the cylinder block by a fixing means.

2. The hydraulic rotary machine according to claim 1, wherein
the fixing means comprises a pin member penetrating through the first slide bearing, and a leading end portion of the pin member fits into a hole provided in the extending portion or the cylinder block.

3. The hydraulic rotary machine according to claim 1, wherein
the fixing means comprises a locking screw penetrating through the first slide bearing, and a leading end portion of the locking screw screws into a screw hole provided in the extending portion or the cylinder block.

4. The hydraulic rotary machine according to claim 1, wherein
the fixing means comprises a locking structure comprising
a bearing side projection portion or a bearing side locking recessed portion formed in the first slide bearing, and
a locking recessed portion or a projection portion formed in the extending portion or the cylinder block, the locking recessed portion engaging with the bearing side projection portion, the projection portion engaging with the bearing side locking recessed portion.

5. The hydraulic rotary machine according to claim 4, wherein
the first slide bearing is formed by molding to the extending portion or the cylinder block.

6. The hydraulic rotary machine according to claim 1, wherein
the fixing means comprises
a bearing side screw portion formed in the first slide bearing, and
a screw portion formed in the extending portion or the cylinder block, the screw portion screwing to the bearing side screw portion.

7. The hydraulic rotary machine according to claim 1, wherein
the working fluid comprises water.

8. The hydraulic rotary machine according to claim 1, further comprising:
a second slide bearing provided in the cover member, the second slide bearing rotatably supporting an outer circumference of the shaft penetrating through the cover member; and
a third slide bearing provided in the case member, the third slide bearing rotatably support one end of the shaft.
